(19) United States
(12) Patent Application Publication
(10) Pub. No.: US 2024/0267609 A1
(43) Pub. Date: Aug. 8, 2024

(54) UNMANNED AUTONOMOUS VEHICLE CAMERABOT

(71) Applicant: CAMHERA LTD, Tel Aviv (IL)

(72) Inventors: Miky TAMIR, Tel Aviv (IL); Michael BIRNBOIM, Holon (IL); Gil SHAMAI, Herzeliya (IL); Shaked DOVRAT, Tel Aviv-Yafo (IL)

(21) Appl. No.: 18/567,528

(22) PCT Filed: Jun. 9, 2022
(86) PCT No.: PCT/IL2022/050618

§ 371 Date: Dec. 6, 2023

Related U.S. Application Data
(60) Provisional application No. 63/212,729, filed on Jun. 21, 2021.

(51) Int. Cl. H04N 23/611; G11B 27/036; H04N 23/66; H04N 23/69; H04N 23/695

(52) U.S. Cl. CPC H04N 23/611; G11B 27/036; H04N 23/66; H04N 23/69; H04N 23/695

(57) ABSTRACT

The disclosure relates to providing a method for video capturing by a camera-equipped drone of an activity of at least one athlete practicing in an area. The method includes the drone hovering in a pre-specified flight zoon, the camera capturing video streams of the area and the practicing athlete thereof, analyzing video streams for an analysis of operations of the athlete and for a decision on desired shooting parameters, determining desired drone maneuvering and desired camera alignment, and the drone executing navigation instructions and desired camera parameter alignment in accordance with the determining of drone maneuvering and camera alignment. The method may also include the drone issuing a signal for the attention of the athlete. Additional optional steps are detecting sports objects, playing field lines and landmarks, detecting and tracking the athlete, detecting a 3D (three dimension) pose of the athlete, recognizing sports events occurring in the area, and recognizing detailed performance parameters. The method may further include retrieving a set of rules for determining a shooting path for the drone, the athlete issuing a signal for the attention of the drone, interpreting the issued signal the drone acting accordingly.

### CROSS REFERENCE

The application claims the priority rights of U.S. provisional patent application No. 63/212,729 entitled “Unmanned autonomous vehicle CAMERABOT” filed Jun. 21, 2021 by M. Tamir, G. Shamai and M. Birnboim, three of the four inventors of the present disclosure.

### BACKGROUND OF THE INVENTION

### Field of the Invention

The invention is in the field of sports video capturing and sports analysis.

### Related Art

Many professional, semi-professional, and amateur athletes feed their fans communities, followers and friends via social media channels such as Facebook, Instagram, TikTok and others, with video clips presenting selected performance moments from their practice sessions. The elite athletes frequently employ a cameraman assistant using a smartphone or camera for that purpose. Later on, when the practice session is over, the captured video is manually edited, audio and graphics integrated and the clip is then uploaded onto the social networks and other distribution channels. Amateurs and youth players frequently ask a friend to shoot the video for them or alternatively they use a fixed camera mounted on a tripod resulting in a very poor video production quality and later on they edit and upload the produced clips themselves. In many cases, uploading such highlights to social networks is monetized using traditional methods like sponsors endorsement or novel ones such as Non-Fungible Tokens (NFT) marketplaces (https://en.wikipedia.org/wiki/Non-fungible_token).

There are two main deficiencies embodied in the processes described above: first, the scope of the human effort required for the manual capture and editing of a clip limits this capability to just few elite athletes that have the necessary resources. Secondly, the quality of a clip produced with a single fixed camera is very limited and cannot thus gain sufficient traction across the above mentioned distribution channels. Clearly, there is a need for a much cheaper way to produce clips of sufficient quality so that a lot more athletes will be able to share their highlight clips with their communities of fans and friends and gain a considerably more interest and traction.

It is the purpose of the current invention to provide affordable means to professional as well as to amateur athletes to produce extremely high quality unique video clips presenting their performance and skills.

Just another purpose of the current invention is to produce the player performance, fitness and analytics data and stats extracted from the drone (or any other adjustable or static camera) video streams.

It is also the purpose of the current invention to provide the training player immediate feedback on his performance either visually using a display monitor, a watch connected to a ground station processor, by audio means using synthetic voice or pre-recorded comments by a speaker, earphones or a smart watch.

### BRIEF SUMMARY OF THE INVENTION

An aspect of an embodiment of the disclosure relates to providing a method for video capturing of an activity of at least one person in an area. The person is associated with an adjustable camera and a processor. The method includes capturing video streams of the area and the activity of the person thereof, analyzing video streams for an analysis of operations of the person, determining camera parameters in accordance with the analysis of operations of the person or persons, and adjusting the camera parameters in accordance with the determining of desired camera parameters.

In some embodiments, the camera parameters include field of view, pan angle, tilt angle, a zoom parameter, and spatial coordinates of the camera.

In some embodiments, the method of claim includes a step of the person triggering an operation of the camera to follow the activity.

In some embodiments, the method includes a step of the person issuing a signal for the attention of the processor, and a step of interpreting the issued signal. Preferably, the signal is captured by the adjustable camera. Preferably, the signal includes a hand gesture or a finger gesture. Most preferably, the hand executing the gesture having a forearm, a palm, a thumb finger, an index finger, a middle finger and a little finger, and the hand gesture includes a combination poses like a forearm-palm angle between 210° and 225°, between 170° and 190°, between 125° and 145°, or between 80° and 100°, a certain finger folded upon the palm, a certain finger separated from adjacent fingers and stretched away of the palm, a pair of certain adjacent fingers attached to one another and stretched away of the palm, a forearm substantially vertical to the ground, and a forearm substantially horizontal to the ground.

Preferably, the method includes a step of acting in accordance with the interpreting of the signal issued by the person. Most preferably, the acting includes step like issuing a signal for the attention of the person, adjusting camera parameters like field of view, pan angle, tilt angle, a zoom parameter and the camera location in space, playing a pre-recorded vocal feedback, playing a synthetic vocal feedback, displaying a message on a screen seen by the person, and triggering of a vibration in a smart watch of the person.

In some embodiments, the method includes a step of submitting video streams to an associated computing device for the analyzing or for clip editing. Preferably, the associated computing device is a smartphone, a laptop computer, a tablet, a remote server, or a combination of a local computing device and a remote server. Preferably, the method includes a step of receiving an edited clip. Preferably, the method includes a step of distributing an edited clip to social media platforms, NFT marketplaces and a sports metaverse environments.

In some embodiments, the person is a player and determining and adjusting the camera parameters respond to player location, player velocity, spread of players, play event recognition, or object detection.

In some embodiments, the method includes a step of calculating present camera parameters using a video stream.

In some embodiments, the adjustable camera is a smartphone, a camera or a camera associated to a smartphone, in communication with the processor. The adjustable camera is held by an adjustable base like a tripod, a pan unit on a tripod, a pan and tilt unit on a tripod, an extender, a stabilizer, or a combination thereof. Alternatively, the adjustable camera is held by a human operator.

In some embodiments, multiple adjustable cameras are located around the area, and the processor determines an identity of a camera to be embedded in the video clip or go on air in a live casting event The processor also determines camera parameters of the adjustable cameras in accordance with the analysis of operations of the person or persons.

An aspect of an embodiment of the disclosure relates to providing a method for video capturing of an activity of at least one athlete practicing in an area, and is associated with a camera-equipped drone. The method includes the drone hovering in a pre-specified flight zoon, the camera capturing video streams of the area and the practicing athlete thereof, analyzing video streams for an analysis of operations of the athlete and for a decision on desired shooting parameters, determining desired drone maneuvering and desired camera alignment in accordance with the analysis and in accordance with the decision, and the drone executing navigation instructions and desired camera parameter alignment in accordance with the determining of drone maneuvering and camera alignment.

In some embodiments, the method includes a step of the drone issuing a signal for the attention of the athlete. Preferably, the signal for the attention of the athlete is an up and down drone motion, a horizontal back and forth drone motion, flickering of a LED (light emitting diode) on a part of the drone to notify a battery shortage, issuing a pre-recorded vocal feedback or a synthetic vocal feedback on performance of the athlete, displaying a message on a screen seen by the athlete, and triggering of a vibration in a smart watch of the athlete.

In some embodiments, the step of analyzing video streams for analysis of operations of the athlete and for a decision on desired shooting parameters includes operations like detecting sports objects, playing field lines and landmarks, detecting and tracking the athlete, detecting a 3D (three dimension) pose of the athlete, recognizing sports events occurring in the area, and recognizing detailed performance parameters.

In some embodiments, the method includes comparing skeleton angles of a player along a drill to corresponding skeleton angles of an elite player.

In some embodiments, the method includes a step of retrieving a set of rules for determining a shooting path for the drone. Preferably, the set of rules includes rules like “track a player”, “move up upon a player throwing a ball”, “track a ball”, “keep a certain object in a center of a field of view”, “move up upon the player getting a certain distance from a certain object”, and “keep all players in a field of view”.

In some embodiments, the method includes a step of the athlete issuing a signal for the attention of the drone, a step of interpreting the issued signal and a step of the drone acting in accordance with the interpreting the issued signal. Most preferably, the method the acting includes steps like issuing a signal for the attention of the athlete, executing a flight maneuver, executing a camera alignment, and providing immediate feedback to the athlete, the immediate feedback responding to performance of the athlete or advising regarding improving performance.

An aspect of an embodiment of the disclosure relates to providing a method for automatic post processing of a video stream of an activity of at least one athlete. The method includes providing the video stream of the athlete or athletes, trimming a clip out of the video stream, adding an audio overlay to the clip, superimposing screen animated graphics on the clip, and delivering the edited clip to an intermediate destination or to a final destination.

In some embodiments, the method includes steps like superimposing 2D/3D graphics attached to objects, superimposing graphics attached to a playing field, adapting clip parameters to requirements of destinations, adding an event driven graphical effect in accordance with an identified event in the clip, converting the clip to a desired clip style, producing a slow motion segment within the clip between automatically recognized play events, adding deep biomechanical performance data or visual to the clip, converting a segmented zone on the area to a desired zone, adding animated labels to the clip, and returning an edited clip to a computing device associated with the athlete.

Preferably, the method includes a step of distributing the clip to social media platforms, NFT (non-fungible token) marketplaces, and sports metaverse environments. Preferably, the audio overlay includes sound effects accompanying certain events.

### BRIEF DESCRIPTION OF THE DRAWINGS

Non-limiting examples of embodiments of the disclosure are described below with reference to figures attached hereto that are listed following this paragraph. Identical features that appear in more than one figure may be labeled with a same label in multiple figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1 is a schematic drawing of a basketball field with a drone capturing a player video during a drill.

FIG. 2A-2E schematically show exemplary five hand gestures used by the athlete to signal a message to the drone.

FIG. 2F schematically shows a hand with a forearm-palm angle at about 220°.

FIG. 3A schematically shows an exemplary signal used by the drone to convey an agreement message to the athlete.

FIG. 3B schematically shows an exemplary signal used by the drone to convey a disagreement message to the athlete.

FIG. 3C schematically shows an exemplary signal used by the drone to convey a battery shortage message to the athlete by flickering a LED (light emitting diode) on a part of the drone

FIG. 4A schematically shows a process which starts with a camerabot capturing a practicing athlete and ends with a video clip distributed to a social media platform, and/or an NFT marketplace and/or a sports metaverse environment.

FIG. 4B is a schematic block diagram of a drone connected to a combination of a ground station and a remote server for capturing, editing and distributing video clips of practicing athletes and for real time interaction with the athletes.

FIG. 4C is a schematic block diagram of an automatic clip editor according to an embodiment.

FIG. 4D is a schematic block diagram of an immediate athlete feedback module interacting with the athlete using an ensemble of feedback devices.

FIG. 5 schematically shows an adjustable camera capturing a person in an area of activity. The camera may have a zoom lens and may be mounted on a tripod, an extender, a stabilizer, and/or a pan and tilt unit.

FIG. 6 is a block diagram of a camera, on a pan and tilt unit, connected to a combination of a local computing device and a remote server for capturing, processing, editing and distributing a video clip of a person or persons and for real time interaction with the person or the persons.

FIG. 7A is a flowchart of a method for video capturing and processing of an athlete by a drone in a free style flight mode.

FIG. 7B is a list of steps of a method for video capturing and processing of an athlete or athletes in a practicing session with a drone which obeys hand gestures signaling specific drills. Theses steps are in addition to some of the steps of FIG. 7A.

FIG. 8 is a flowchart of a method for automatic post-processing of a video stream of a practicing athlete or practicing athletes.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the disclosed invention is necessary to implement the invention. Various elements and features of the invented article are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

It is the purpose of the current invention to provide affordable means to professional as well as to amateur athletes to produce extremely high quality unique video clips presenting their performance and skills.

Using artificial intelligence and computer vision technologies, the current disclosure suggests providing a fully automatic and professional video and automatic postproduction services to athletes of all tiers from all sports types. For that sake, the current disclosure suggests using an intelligent adjustable or moving camera in order to prepare exceptional and immersive video clips for distribution in a variety of channels.

An adjustable camera is a camera possibly characterized by seven degrees of freedom, three location coordinates, a pan angle, a tilt angle, a roll angle and a zoom parameter. Exemplary adjustable camera is an autonomous camera-equipped commercial drone. Another exemplary adjustable camera is a remote controlled zoom camera on a tripod. Another example is a camera mounted on a pan and tilt unit.

The software autonomously controls drones and/or adjustable cameras and determines their dynamic pan, tilt, roll and zoom and position parameters in order to capture optimal video of the covered sports event. The captured video is processed in real time to obtain comprehensive understanding of the scene. That understanding is achieved by employing techniques like player gesture recognition, detection of playing field lines and other landmarks, detection of player 3D pose, face recognition, and recognition and detection of objects such as ball, hoops, goals.

Drone companies have been incorporating smart features into their consumer drones (https://dronerush.com/best-drones-1977/) to allow for an easier and better experience for customers. One of the first smart features added was a “follow me” mode. This is a smart flight feature that allows a drone to autonomously follow an owner, or another selected object.

The current invention deals with comprehensive understanding of specific sports scenes, thus converting the drone or another adjustable camera into a personal robotic camera with expertise in the specific sports.

Just another purpose of the current invention is to produce the player performance, fitness and analytics data and stats, by extracting that data from the video streams.

It is also the purpose of the current invention to provide a training player immediate feedback on her/his performance either visually using a display monitor, or by a smart watch connected to a ground station processor or by audio means using synthetic or pre-recorded voice by a speaker, earphones or the above mentioned smart watch.

Throughout the disclosure, a drone, a server or a processor executes operations which necessitates intelligence, like face recognition, gesture detection, clip editing. These devices acquire such abilities by being trained by methods of artificial intelligence, machine vision, and deep learning. The training might be for a certain player of a specific sports, for all players of a specific sports, for all players of all sports.

While basketball is used throughout the disclosure as an example, the outlined invention may be used in other team sports as well as for non-team sports like swimming and running

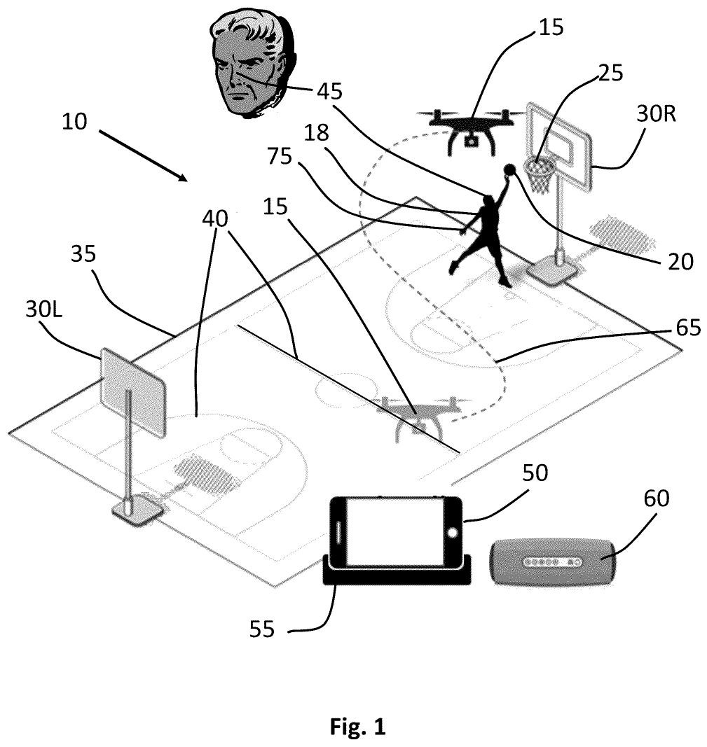

### An Athlete Captured by a Camera-Equipped Drone Embodiment (FIGS. 1-4)

By a way of example only, basketball is used to present an athlete or a player practicing in a field. FIG. 1 is a schematic drawing of a basketball field 10 with a camera-equipped drone 15 capturing a player 18 performing a drill. The basketball field includes objects that the drone or an associated processor is trained to detect and identify, like a ball 20, hoop 25, backboards 30R and 30L, side line 35, and field line 40. The associated processor is also trained to recognize and authenticate a face 45 of player 18. The player may wear a smart watch 47 on one of the hands.

The drone may be launched by the player before he/she starts practicing using a ground station, a smartphone 50 for example. During the practicing, the smartphone lays on a seat 55 and communicates with the drone, via a manual controller (not shown) of the drone, for example. In addition, a speaker 60 may be connected by a wire or wirelessly to the smartphone, and may deliver vocal messages to the player using a synthetic voice or a pre-recorded human voice.

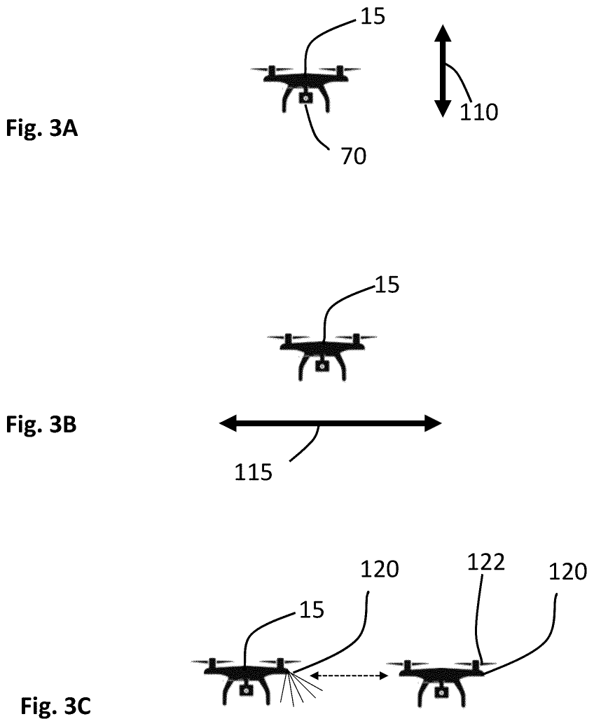

During the practicing, drone 15 flies over a trajectory 65 such that it follows the player during the drill and an attached camera 70 (see FIG. 3A) shoots a video stream from an optimal angle. To this aim, a variety of rule sets for drone flight trajectories 65 are stored in a library, and during a drill one of the stored rule sets may be retrieved and may guide the drone to follow an elected set of rules that leads to a trajectory 65. A set of rules that define the trajectory includes rules like track the player, move up when the player throws the ball, etc. In case of multiple players, a possible rule is “keep all players in the field of view”.

Along a session of practicing, a flight mode may be switched between two flight modes. In a free style flight mode, the drone flight is not managed directly by the player, who may devote all attention to the drill and actually “forgets” the drone presence. The flight trajectory is determined in real time by analysis and interpretation of the actions of the player or of the players. In case of multiple players, the flight trajectory is determined by their actions and spread on the field. In contrast, a player guided flight mode is managed to some extent by the player, who signals the drone by a gesture of a hand 75, for example. By a way of example only, the player may initiate the flight and video capturing by a hand gesture, may continue with practicing while the associated processor monitors the player based on analysis of the actions and of the body poses while the player is focusing all attention on the drill. Finally, the drone lands following a hand gesture of the player, that signals the end of a session.

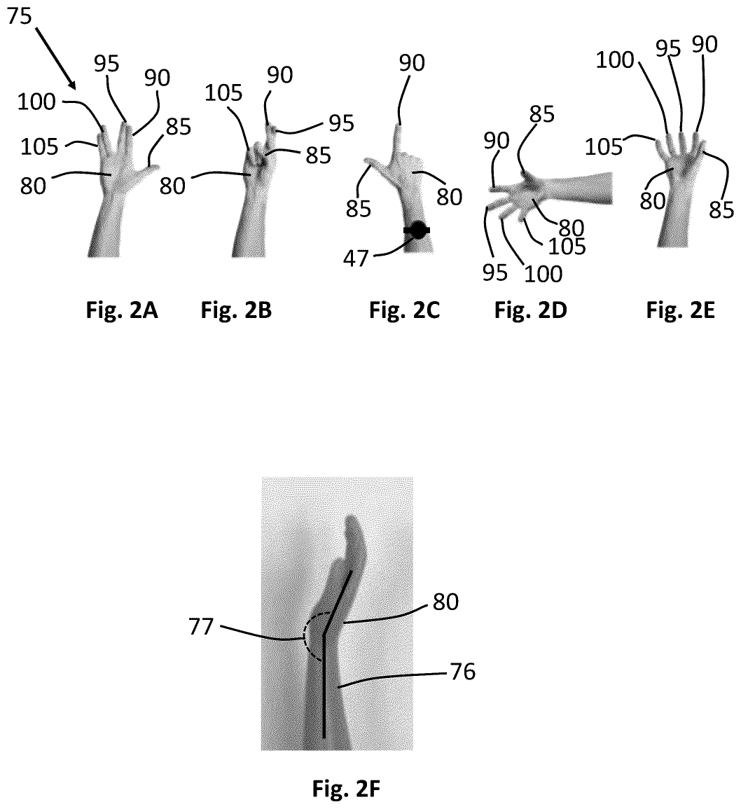

FIG. 2A-2E schematically show an exemplary suite of hand gestures used by athlete 18 to signal a message to drone 15. A hand 75 which executes the gesture includes a forearm 76, a palm 80, a thumb (or thumb finger) 85, an index finger 90, a middle finger 95, a ring finger 100 and a little finger 105.

FIG. 2A shows a partially open hand 75 substantially posed vertical to the ground with the index finger attached to the middle finger, the ring finger attached to the little finger, and the thumb stretched away from the index finger.

FIG. 2B shows a partially open hand 75 substantially posed vertical to the ground with the index finger attached to the middle finger and both pointing up, while the ring finger and the little finger being folded down on the palm, and the thumb rests folded on the ring and the little finger.

FIG. 2C presents a partially open hand 75 substantially posed vertical to the ground with the index finger pointing up, the thumb in a slope position relative to the ground, and the middle finger, the ring finger and the little finger folded down on the palm.

FIG. 2D shows an open hand 75 substantially posed parallel to the ground while a plane defined by the fingers substantially posed vertical to the ground.

FIG. 2E presents an open hand 75 substantially posed vertical to the ground with a plane defined by the fingers also substantially posed vertical to the ground.

By a way of an example, a player has a list of five drills that he is practicing their performance, and for each of them there is a set of flight mode rules which is stored in advance in an application with which the smartphone directs the drone and its camera. Suppose, for example, that the player intends to perform the third drill in the list. Then, the player signals the drone with the hand gesture of FIG. 2C, the camera captures the hand gesture and delivers the captured video stream to the smartphone. The application identifies the hand gesture as the one signaling an intention to perform the third drill, retrieves appropriate set of flight mode rules and delivers drone 15 instructions for maneuvering, camera alignment and shooting, such that it follows the selected flight mode rules.

For example, the hand gesture of FIG. 2A notifies drone 15 that player 18 plans to approach right backboard 30R from the left side and execute a dunk shot. Accordingly, the drone is posed to follow the dribbling player, to climb up above the right basket pole when the player gets at a given distance from the backboard and capture the dunk shot from a place exactly above hoop 25. Similarly, following a successful drill, the player might call the drone using the hand gesture of FIG. 2D, for example, to come closer for a selfie shot and to record a speech by the player.

In general, there is a lot of possible hand gestures different from each other. A partial set of hand gestures, which are relatively easy to distinguish from one another may be defined as a combination of poses like a forearm-palm angle at a certain range, a certain finger folded upon the palm, a certain finger separated from adjacent fingers and stretched away of the palm, a pair of certain adjacent fingers attached to one another and stretched away of the palm, a forearm substantially vertical to the ground, and forearm substantially horizontal to the ground.

FIG. 2F shows an example of a forearm 76 and a palm 80 having an angle 77 in between which is about 2200. Possible forearm-palm angles are between 2100 and 225°, between 1700 and 1900, between 1250 and 1450, and between 80° and 1000.

Drone 15 may signal athlete 18 as well. It may signal the player as feedback to the player performance or in a response to a signal submitted by the player to the drone. FIGS. 3A-C schematically show three exemplary signals that the drone may execute.

FIG. 3A shows an exemplary signal used by the drone to communicate an agreement message to the athlete. To this aim, the drone executes an up and down motion, as designated by a vertical double arrow 110.

FIG. 3B shows an exemplary signal used by the drone to communicate a disagreement message to the athlete. To this aim, the drone executes a right to left motion, as designated by a horizontal double arrow 115.

FIG. 3C schematically shows an exemplary signal used by the drone to communicate a battery shortage message to the athlete. For that message, the drone flickers a LED (light emitting diode) 120 positioned under of a drone rotor 122.

In addition, the smartphone may signal the athlete without involvement of the drone. Exemplary signals are issuing vocal feedback on performance of the athlete using speaker 60, displaying a message on a large screen (not shown) deployed such as to be seen by the player while he practices, and initiating a vibration in a smart connected watch 47 (see FIG. 2C) of the athlete.

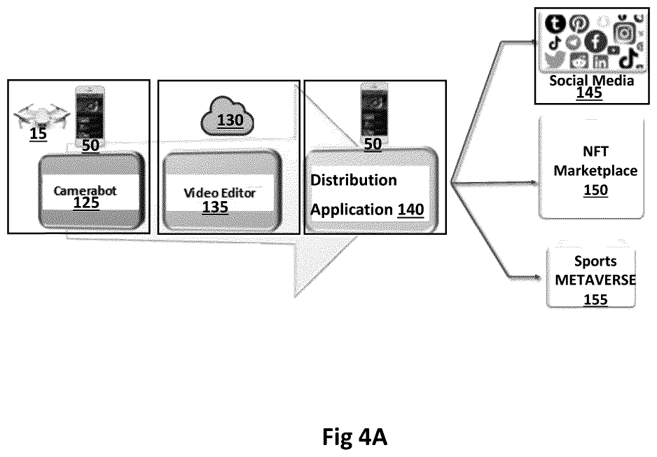

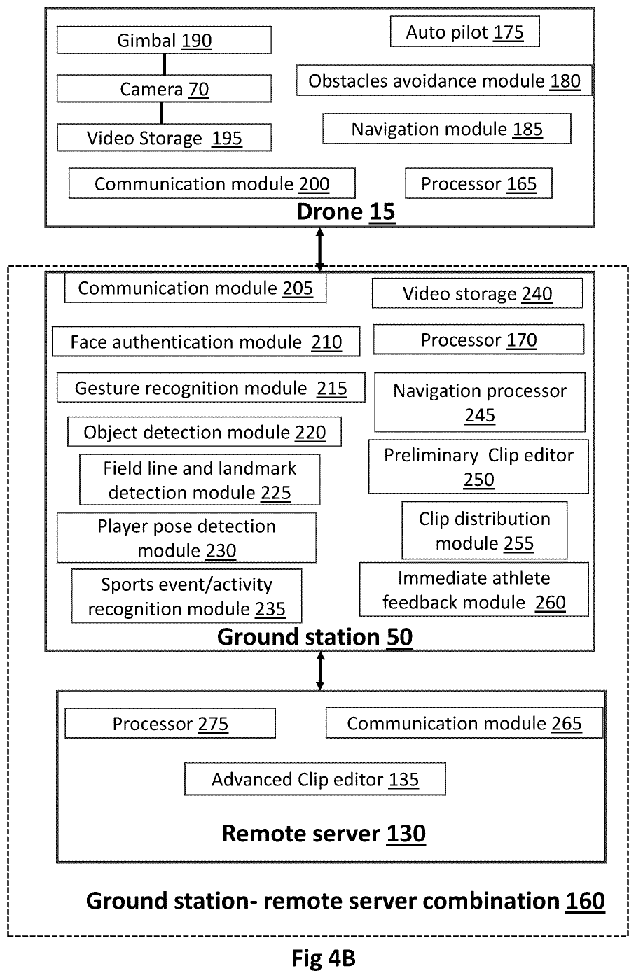

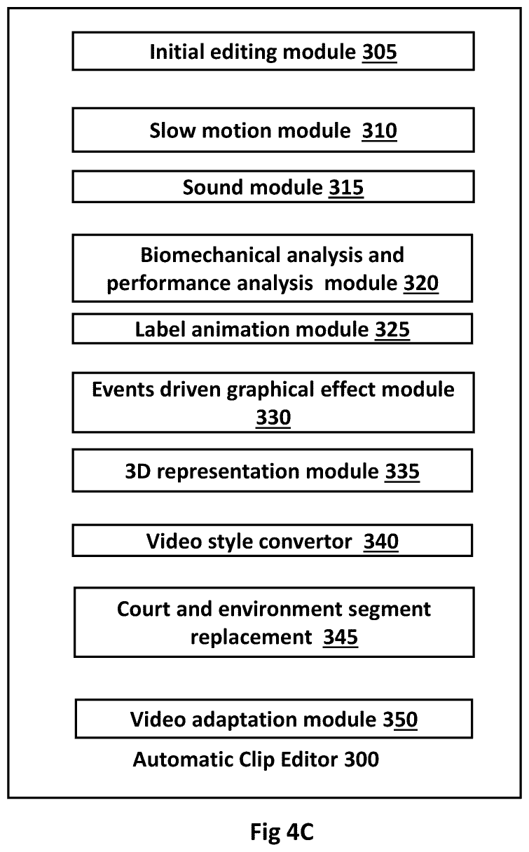

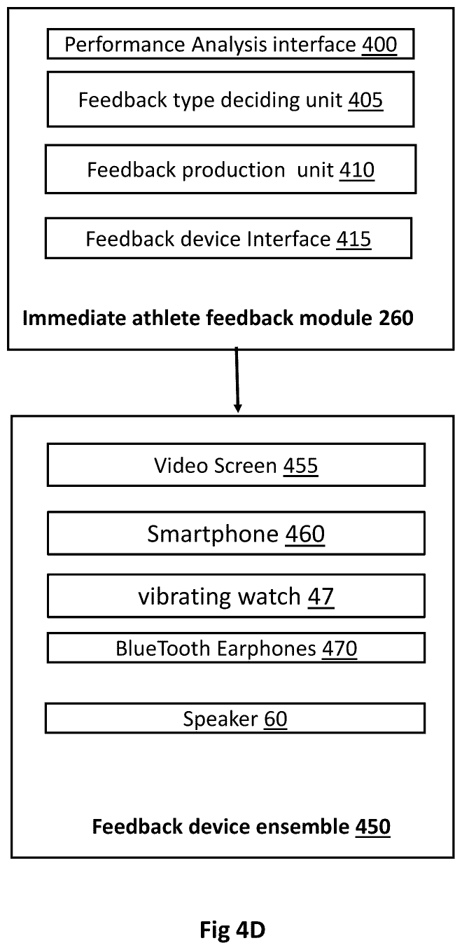

Recalling that one purpose of the disclosure is to produce a video clip of the practicing athlete, reference is made to FIG. 4A, which shows a schematic process of capturing, editing and distributing the video clip. A camerabot 125 captures a practicing athlete 18. The camerabot 125 includes a drone 15 and a smartphone 50. The captured video stream is sent to a remote sever, a cloud server 130 for example, having an automatic video editor 135. The resulted video clip may be sent back to smartphone 50 for preview and distribution by application 140. Exemplary distribution destinations are a social media platform 145, an NFT marketplace 150 and a sports metaverse environment 155.

For a detailed description of the building components appearing in FIG. 4A, reference is made to FIGS. 4B-4D. FIG. 4B is a schematic block diagram of a drone 15 connected to a combination 160 of a ground station 50 and a remote server 130. Each of the drone, ground station and remote server has a variety of modules for execution of a variety of tasks.

It is noted that the allocation of modules and capabilities between elements 15, 50 and 130 is described here as a way of example only. The actual allocation of the modules may be different to a certain extent in accordance with the technological development of wireless communication and computing power, and in accordance with actual system design decisions. This flexibility is especially essential regarding the internal module allocation in the combination 160, which may be found somewhere between two extreme situations. In one situation, a ground station may have a sufficient computing power to perform all tasks and give up a service of a remote server. On the other hand, the tasks of a ground server may be handed over to a remote server should the drone have a sufficient computing power and communications capability to interact directly with the remote server. Consequently, a drone 15 and/or a camera 70 interact with an associated computing device 160 which may be selected from a smartphone ground station, a laptop computer ground station, a tablet ground station, a remote server, and a combination of a ground station and a remote server.

Drone 15 may be an autonomous drone. In one embodiment, the drone is a commercial off the shelf drone and which leaves all the processing to the ground station. In that configuration, the drone communicates the camera video stream to the ground station and the ground station transmits just navigation and camera pose and zoom instructions to the drone using its commercial SDK (software development kit).

In another embodiment, at least a portion of the software and algorithms is implemented on a processor 165 of drone 15. The other portion of the software is implemented on a processor 170 of the ground station. Processing algorithmic data is exchanged between processor 165 and processor 170.

In the example of FIG. 4B, drone 15 includes flight aids like an auto pilot 175, an obstacles avoidance module 180, and a navigation module 185. The flight aids enable flying, maneuvering, hovering, tilting, etc. The drone also includes a camera 70 on a 2D/3D gimbal 190, a video storage 195, and a communication module 200. These modules enable video capture, storage and transmission. The camera might have a zoom option, and the gimbal may be tilted two or three-dimensionally relative to a plane defined by the drone rotors. Communication module 200 interacts with a communication module 205 of ground station 50.

In a way of an example, the ground station of FIG. 4B includes the following modules:
A face recognition or authentication module 210, which identifies and authenticates a face 45 of the player. For that sake, the drone is instructed to approach the player and acquire sufficient resolution of the face. Alternatively, the camera is instructed to zoom in on the face.
A gesture recognition module 215, which identifies a specific hand gesture out of a pre-programmed library of gestures like the five gestures of FIGS. 2A-2E.
An object detection module 220 which detects and tracks objects like player 18, ball 20, hoops 25, goal in a soccer match and a puck in ice hockey. Detection and tracking may be made using classic computer vision methods (en.wikipedia.org/wiki/Computer_vision) or preferably Artificial Intelligence Deep Learning methods. The YOLO (You Only Look Once) framework (https://en.wikipedia.org/wiki/Object_detection), for example, is a very popular method to deal with object detection. YOLO takes the entire image in a single instance and predicts the bounding box coordinates and class probabilities for these boxes. The biggest advantage of YOLO is its superb speed as it may process 30 frames per second, in dependence on the available processing power.
A field line and landmark detection module 225, which may also use classic computer vision or deep learning methods (en.wikipedia.org/wiki/Deep_learning). Detected field lines as well as other landmarks on the playing field are used to extract the momentary seven, location, pose and zoom degrees of freedom of the drone camera needed to plan a video capture flight path 65, and to map objects from their location on the camera's sensor plane to their location in the real world. This capability enables, for example, drawing the player's trajectory on the court or field.
A player poses detection module 230, which extracts 2D or 3D player skeleton, detects and interprets player gestures. The 2D/3D skeleton provides player performance parameters such as his shooting biomechanics in basketball. It is a motion capture tool used as a coaching and analytics tools comparing the body pose to an ideal one for a given task. This can be done using OpenPose (github.com/CMU-Perceptual-Computing-Lab/openpose), the first real-time multi-person system to jointly detect human body, hand, facial, and foot key-points (a total of/35 key-points) on a single image. It had been proposed by researchers at Carnegie Mellon University, who had released it in the form of a Python code, C++ implementation and a Unity Plugin. These resources are available in OpenPose repository.
A sports event/activity detection module 235, which automatically detects a significant event happening, like scoring a goal in soccer, a dunk in basketball, a sea surfer going underneath a wave. Event detection may evoke a pre-programmed or formerly listed video capture trajectory 65 of the drone and the camera pose.

Player pose detection module 230 is used for either real time drill analysis or post drill analysis, and thus provides performance analysis of the drill for the player and for a coach (not shown). For example, the body pose of a basketball player 18 while throwing a ball 20 may be compared to the pose of an elite player. Such a comparison can be implemented, for example, by comparing the player skeleton angles to the angles of the elite player throughout the throw process. Consequently, pose correction recommendations may be immediately conveyed to the player visually or vocally. Vocal real time analysis may be channeled to a portable speaker 60 and heard by the player and/or by the coach. Visual feedback by means of a video screen or monitor (not shown) may be used as well, as further detailed below.

Additional modules in the ground station are a video store 240, a processor 170, a navigation processor 245, a communication module 205, a preliminary clip editor module 250, a clip distribution module 255, and an immediate athlete feedback module 260. The immediate athlete feedback module is further detailed in reference to FIG. 4D.

In the example of FIG. 4A, remote server 130 communicates with ground station 50 using a communication module 265, and uses an advanced clip editor 135 for real time or post processing of the video stream transmitted from the drone via the ground station. For that sake, the remote server is equipped with powerful computing capabilities, like a processor 275.

Clip distribution module 255 distributes the clips to a variety of distribution channels, social media sites or platforms 145, for example. It may coordinate the clip distribution with clip editors 250 or 135 such as to tune various clip parameters to the distribution channels. Exemplary parameters are the clip duration and the video aspect ratio which should obey guidelines of a destined distribution channel.

In an alternative embodiment, a drone processor 165 may host software modules like a face recognition module 210, a gesture recognition module 215, and a navigation processor, which appear in FIG. 4B as hosted by ground station 50.

In the embodiment of FIG. 4B, some clip editing, mainly the real time editing, is done by preliminary clip editor 250, while some clip editing, mainly the post processing or the preparation for distribution, is done by advanced clip editor 135. As the workload division between the two clip editors may be varied in accordance with the available computing resources in each computing device, FIG. 4C shows a schematic block diagram of an automatic clip editor 300 which may be implemented in a single hardware device, or in two hardware devices. Namely, in some embodiments clip editor 300 is a virtual clip editor hosted by combination 160.

Automatic clip editor 300 includes modules from the following list:
An initial editor 305, which trims a clip out of a video stream received from a camera 70 or retrieved from a video storage 195 or 240, crops frames, if necessary, enhances images and correct them as desired. This trimming is done automatically and is based on automatic detection of sports events and actions. The initial editor allows the player or other team member to use a suite of professional VFX (visual effects) tools to enhance the video clip.
A slow motion module 310, which copies a certain video segment and presents it in a slow motion mode. To this aim, the editor automatically detects two successive events like ball throw and score in a basketball drill and converts the time segment between the two events to slow motion.
A sound module 315, which integrates an acoustic overlay with the clip. For example, Sound effects like explosions and others can also be triggered by an automatically detected game event.
A biomechanical analysis and performance module 320, which executes a biomechanical analysis of the athlete motion, and analyzes the performance of the athlete in terms of the specific sport. The module presents analysis results on the clip, or submits them elsewhere, to the attention of a coach, for example. Such analysis can be further gamified, for example comparing the 3D skeletons angles throughout the throw event in basketball to the angles of a model or a well known player.
A label animation module 325, which enriches the clip with animated labels. Such a label may be attached to an object and kept hidden until a detected game event triggers its appearance. Also, a label may be attached to the playing field or fixed in screen coordinates.
An event driven graphical effect module 330, which superimposes graphical animations fixed on screen coordinates, attached to moving objects or to the playing field in accordance with an event occurring in the clip and detected automatically.
A 3D representation module 335. The volumetric video capture of the athlete might be executed before or after the drill. As a response to a dedicated gesture (for example a T-pose position) the drone starts a helical motion around the player and performs 3D scanning of his body. The distances of the helix from the athlete and the drone's speed are determined such as to capture consecutive frames of body parts so that there is an overlap between the frames. The processing is done by the remote server or by ground station processors. The processor locates joint features or landmarks on consecutive frames to reconstruct an accurate 3D model of the athlete. This process can be done using commercial 3D reconstruction (photogrammetry) software codes, seehttps://www.sculpteo.com/en/3d-learning-hub/3d-printing-software/photogrammetry-software.
An artistic video style transfer module 340, which converts the style of the clip to a desired video style using deep learning techniques in accordance with an appropriate video style guide, for example, https://arxiv.org/abs/1604.08610.
A court and environment segment replacement 345, based on semantic segmentation, which is a process of assigning a label to every pixel in the image enabling replacing of an object or a zone with another object and zone. For example, the tribune zone of the court are replaced with the tribunes of a well known stadium or with the north pole landscape. Github options can be found at https://github.com/mrgloom/awesome-semantic-segmentation.
A video adaptation module 350, which adapts the clip parameter, duration for example, to requirements of a destination of the clip.

FIG. 4D is a schematic block diagram of an immediate athlete feedback module 260, which interacts with feedback devices out of an ensemble 450 of feedback devices. The feedback module includes a performance analysis interface 400 which receives performance data from module 320, for example, a feedback type deciding unit 405 which decides what is the feedback type most appropriate for the received performance data, a feedback production unit 410 which produces an actual feedback and sends it to the feedback devices in ensemble 450 through a feedback device interface 415.

The feedback device ensemble includes a video screen 455 disposed in a field location such that athlete 18 is able to see it, a smartphone 460 carried by the athlete and issuing a ring, a vibration or a vocal message, a vibrating connected watch 47 like an apple watch that vibrates upon receiving an appropriate signal from interface 415, BT (BlueTooth) earphones 470, and speaker 60 which issues a sound or a vocal message loud enough to be heard by the athlete.

In some embodiments, the athlete is practicing without any intervention or even presence of any other person. The coach, for example, may be involved while residing in a remote place by receiving data and video clip from either the ground station or remote server.

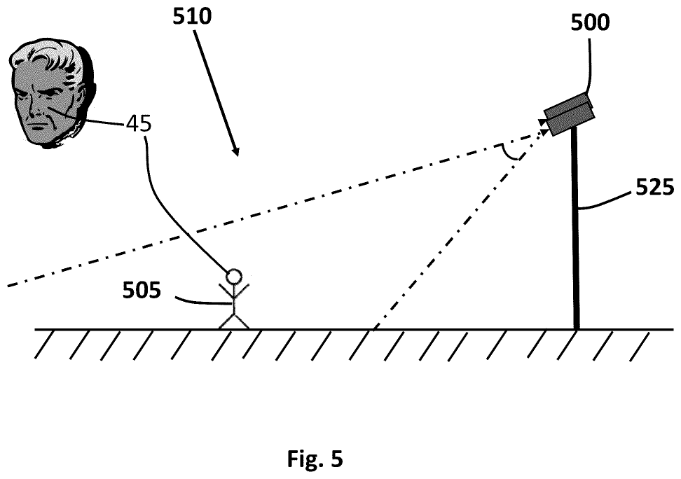

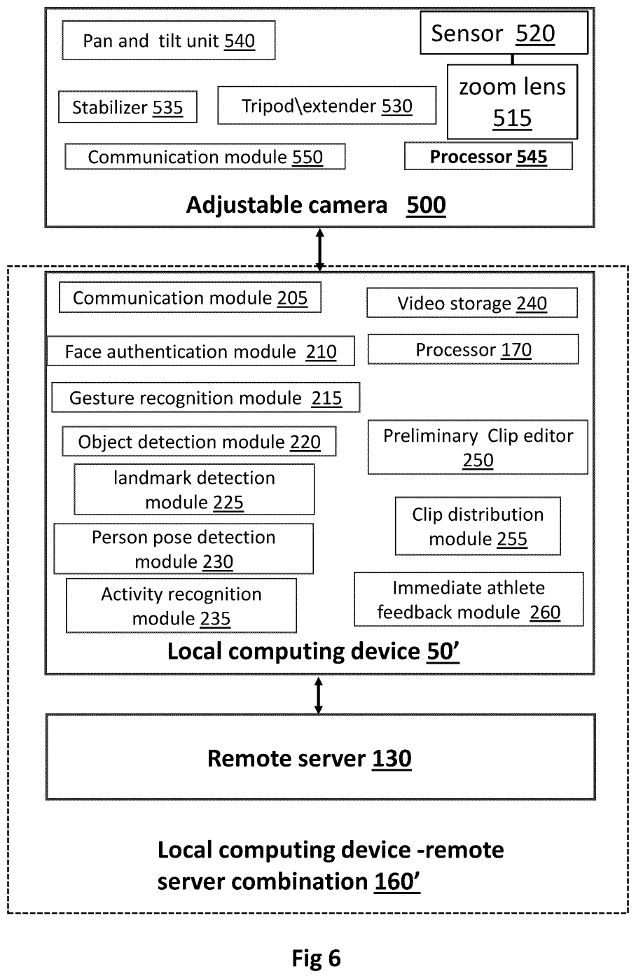

### An Embodiment of a Person or Persons Captured by an Adjustable Camera (FIGS. 5-6)

FIGS. 5 and 6 schematically show an adjustable camera 500 capturing a person 505 in an area of activity 510. A zoom lens 515 is attached to a sensor 520 of camera 500. The camera is mounted on a post 525, a tripod/extender 530, a stabilizer 535, and/or a pan unit and tilt unit 540.

In an embodiment, the camera has a processor 545 and a communication module 550.

Camera 500 is connected to a combination 160′ of a local computing device 50′ and a remote server 130 for capturing, processing, editing and distributing a video clip of the person or persons and for real time interaction with the person or persons. Local computing device 50′ includes some or all the modules of ground station 50, let alone navigation processor 245. Remote server 130 is described above in reference to FIG. 4B. The functions of the modules of ground station 50′ are detailed above in relation to ground station 50 or below.

### An Embodiment of a Method for Capturing an Athlete by a Camera-Equipped Drone (FIGS. 1-4, 7)

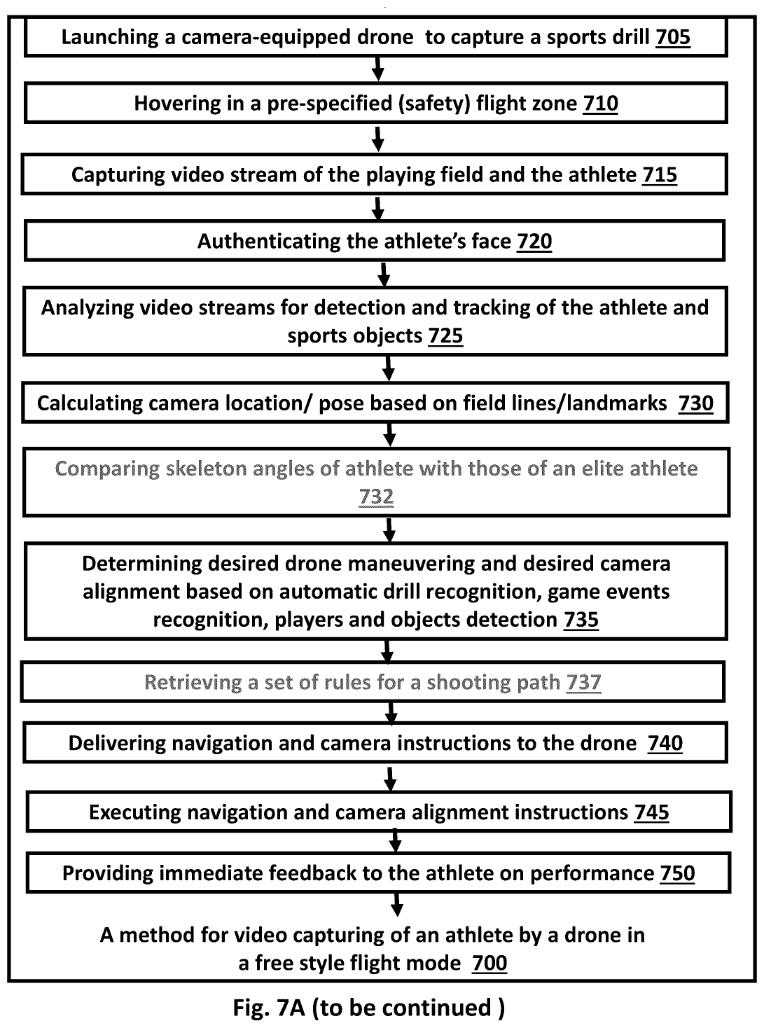

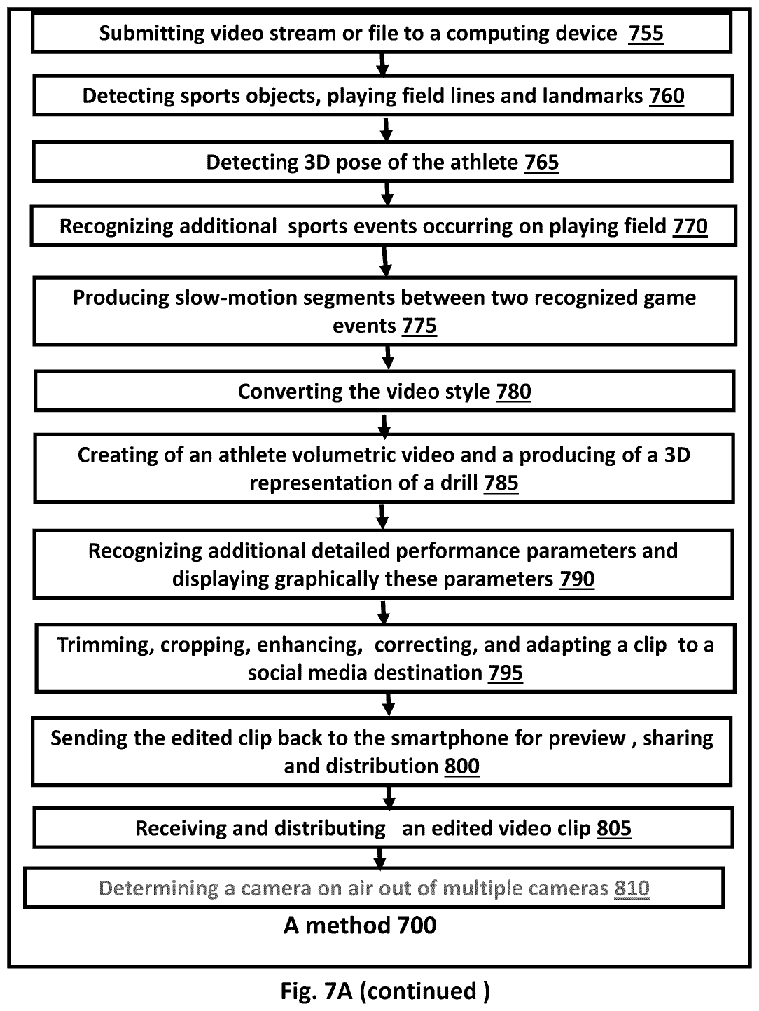

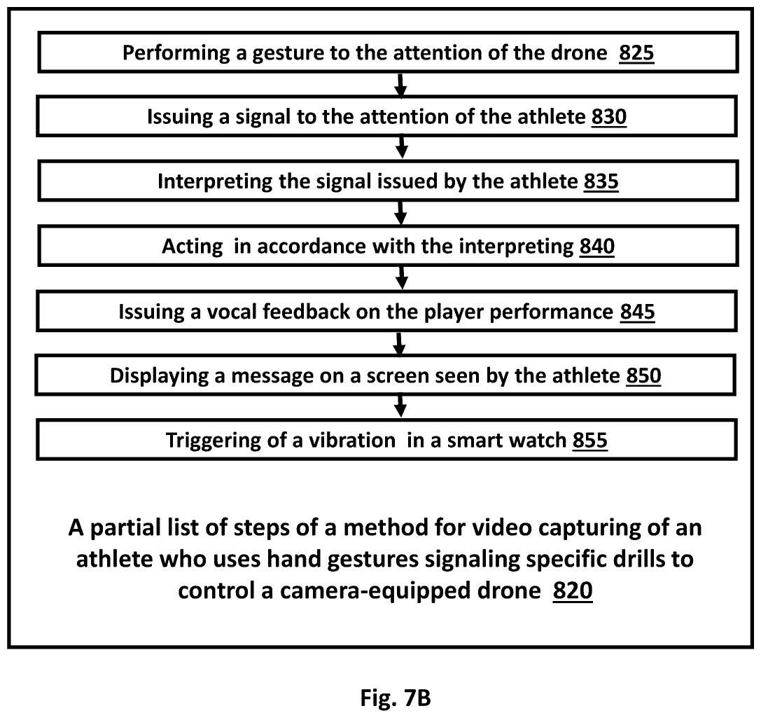

A method 700 for video capturing of an activity of an athlete 18 in an area or field 10 is disclosed in a flowchart of FIG. 7A. Athlete 18 is associated with a camera-equipped drone 15 and a ground station-remote server combination 160, as shown in FIGS. 1 and 3A.

Method 700 include a step 715 of a camera 70 capturing video streams of the sports field and the practicing athlete thereof, and a step 725 of analyzing video stream for an identification of operations of the athlete and for a decision on desired shooting parameters. The method further includes a step 735 of determining corresponding desired drone maneuvering and desired camera alignment. The method also includes a step 745 of the drone executing navigation instructions and desired camera parameter alignment in accordance with the step 735 of determining of drone maneuvering and camera alignment.

A series of steps, including the above steps as well as additional optional steps as detailed below, is repeated again and again throughout a drill conducted by the athlete.

In an embodiment, the athlete launches, in step 705, camera-equipped drone 15 to capture a planned sports drill. Further, in step 710, the drone hovers in a pre-specified safety flight zone and captures the sports field.

In some embodiments, method 700 further comprises a step 720 of authenticating a face 45 of an athlete 18.

In some embodiments, method 700 further comprises a step 755 of submitting video streams to an associated computing device 160 for performing step 725 of analyzing or for clip editing. Preferably, the associated computing device is a smartphone 50, a laptop computer, a tablet, a remote server 130 or a combination 160 of a ground station 50 and a remote server 130.

In some embodiments, method 700 further comprises a step 805 of receiving an edited clip and distributing an edited clip to social media platforms 145, NFT marketplaces 150 and sports metaverse environments 155.

Preferably, method 700 includes a step 725 of analyzing video streams for an identification of operations of the athlete and for a decision on a desired camera alignment includes steps like step 760 of detecting sports objects, playing field lines and landmarks, a step of detecting and tracking the athlete, a step 765 of detecting a 3D (three dimension) pose of the athlete, a step 770 of recognizing sports events occurring in the area, and a step 790 of recognizing detailed performance parameters.

Preferably, method 700 further includes a step 730 of calculating the drone and camera location and pose based on field lines 40 and landmarks like side lines 35, backboards 30R and 30L.

Preferably, the method includes a step 732 of comparing skeleton angles of the player along a drill to corresponding skeleton angles of an elite player.

Preferably, step 735 includes a task 737 of retrieving a pre-programmed shooting path or trajectory 65, or a set of flight mode rules which results in a trajectory 65.

Preferably, method 700 includes a step 740 of delivering navigation and camera alignment instructions to drone 15.

Preferably, method 700 includes a step 750 of providing immediate feedback to athlete 18 on the performance using a feedback device of an ensemble 450.

In some embodiments, method 700 includes one or more of a step 775 of producing slow-motion segments between two recognized game events, a step 780 of converting a video style of a video clip to a desired style, a step 785 of creating a volumetric video of an athlete and producing of a 3D representation of a drill, and a step 800 of sending the edited clip back to the smartphone for preview by the athlete, sharing with fans and distribution to social media platforms 145, NFT marketplaces 150 and sports metaverse environments 155.

The method described above includes some interaction between athlete 18 and drone 15 in accordance with a free style mode of operation of the drone. In a session, the free style flight mode may be switched by a player guided mode of operation, when athlete 18 is much more active in the interaction with drone 15, respectively, as expressed in FIG. 7B which lists a partial list 820 of steps of a method for video capturing during the player guided mode phase.

Under the player guided mode of operation, method 700 comprises a step 825 of athlete 18 issuing a signal for the attention of drone 15, of a processor 165 or of a processor 170, a step 835 of interpreting the issued signal and a step 840 of acting in accordance with the step 835 of interpreting the issued signal. Preferably, the signal issued by athlete 18 includes a hand gesture. Most preferably, the hand gesture is one of the hand gestures described above in reference to FIG. 2A-2E. For the sake of brevity, the details of the hand gestures are not repeated here.

Preferably, processor 165 or processor 170 is able to communicate with the athlete 18, and the step 840 of acting includes steps like a step 830 of issuing a signal for the attention of the athlete or the person, and a step 745 of adjusting or aligning camera 70.

In some embodiments, the step 840 of acting includes steps like step 830 of issuing a signal for the attention of the athlete, a step 745 of executing a flight maneuver, and a step 745 of executing camera alignment. Preferably, drone 15 issues a signal like an up and down motion to signal agreement in response to a signal issued by athlete 18, a horizontal back and forth motion to signal disagreement in response to a signal issued by the athlete, and a signal of flickering of a LED (light emitting diode) on a part of the drone to signal a battery shortage. In addition, drone 15 may issue a step 845 of issuing of a vocal feedback on performance of the athlete, a step 850 of displaying of a message on a screen seen by the athlete, and a step 855 of triggering a vibration in a smart connected watch 47 or a smartphone of the athlete.

### An Embodiment of a Method for Capturing a Person or Persons by an Adjustable Camera (FIGS. 5-7)

A method 700 for video capturing of an activity of a person or persons 505 in an area 510 is disclosed in a flowchart of FIG. 7A. Person 505 is associated with an adjustable camera 500 and a processor 545.

Method 700 includes a step 715 of capturing video streams of area 510 and the person activity thereof, a step 725 of analyzing a video stream for an identification of operations of the person or persons, a step 735 of determining desired camera parameters in accordance with the identification of operations of the person or persons, and a step 745 of adjusting camera parameters in accordance with the determining of desired camera parameters.

In some embodiments, method 700 further comprises a step 705 of the person or persons triggering an operation of the camera to follow the activity.

In some embodiments, method 700 further comprises a step 720 of authenticating a face 45 of a person 505.

In some embodiments, method 700 further comprises a step 755 of submitting video streams to an associated computing device 160′ for performing step 725 of analyzing or for clip editing. Preferably, the associated computing device is a smartphone 50′, a laptop computer, a tablet, a remote server 130 or a combination 160′ of a ground station 50′ and a remote server 130.

In some embodiments, method 700 further comprises a step 805 of receiving an edited clip and distributing an edited clip to social media platforms 145, NFT marketplaces 150 and sports metaverse environments 155.

Preferably, the method further includes a step 725 of analyzing video streams for an identification of operations of the person 505 and for a decision on a desired camera alignment includes steps like step 760 of detecting objects and landmarks, a step of detecting and tracking the person or persons, a step 765 of detecting a 3D (three dimension) pose of the person, a step 770 of recognizing events occurring in the area, and a step 790 of recognizing detailed performance parameters.

Preferably, method 700 further includes a step 730 of calculating the current camera location and pose based on objects that their dimensions and spatial position is known. Such objects are side lines 35, field lines 40 and a backboard 30R. For example, three parameters, pan angle, tilt angle and zoom ratio, of a PTZ camera are determined automatically and dynamically according to player locations, to ball location, to backboard location or to an event like a player approaching the hoop.

Preferably, step 735 includes a task 737 of retrieving a pre-programmed shooting plan or a set of rules to determine such a shooting plan.

Preferably, method 700 includes a step 750 of providing immediate feedback to person 505 on the performance using a feedback device of an ensemble 450.

In some embodiments, method 700 includes one or more of a step 775 of producing slow-motion segments between two recognized events, a step 780 of converting a video style of a video clip to a desired style, a step 785 of creating a volumetric video of the person or persons and producing of a 3D representation of the action of the person or persons, and a step 800 of sending the edited clip back to the smartphone for preview by the person or persons, sharing with followers and distribution to social media platforms 145, NFT marketplaces 150 and sports metaverse environments 155.

The method described above includes some interaction between person 505 and camera 500 in accordance with a free style mode of operation of the camera. In a guided mode of operation, person 505 is much more active in the interaction with camera 500, as expressed in FIG. 7B which lists a partial list 820 of steps of a method for video capturing under the guided mode of operation.

Under the guided mode of operation, method 700 comprises a step 825 of person 505 issuing a signal for the attention of a processor 545 or of a processor 170, a step 835 of interpreting the issued signal and a step 840 of acting in accordance with the step 835 of interpreting the issued signal. Preferably, the signal issued by person 505 includes a hand gesture. Most preferably, the hand gesture is one of the hand gestures described above in reference to FIG. 2A-2E. For the sake of brevity, the details of the hand gestures are not repeated here.

Preferably, processor 545 or processor 170 is able to communicate with person 505, and the step 840 of acting includes steps like a step 830 of issuing a signal for the attention of the person or persons, and a step 745 of adjusting or aligning camera 500.

In some embodiments, the step 840 of acting includes steps like step 830 of issuing a signal for the attention of the person or persons, and a step 745 of executing camera alignment. Processor 545 or processor 170 may issue a step 845 of issuing of a vocal feedback on actions of the person or persons, a step 850 of displaying of a message on a screen seen by the person or persons, and a step 855 of triggering a vibration in a smart connected watch 47 or a smartphone of the person or persons.

In an embodiment, there are multiple fixed PTZ cameras 500 located in various locations around a region of action 510. The PTZ parameters of each camera are automatically and dynamically determined according to person locations, objects, events, etc. Additionally, an automatic cut between the cameras, which determines the camera that goes on air, is automatically done based on events occurring in area 510.

The method 700 includes a step 810 of determining a camera 500 on air out of the multiple cameras.

### An Embodiment of a Method for Post Processing Video Stream (FIGS. 1, 4A, 4B, 4C, 8)

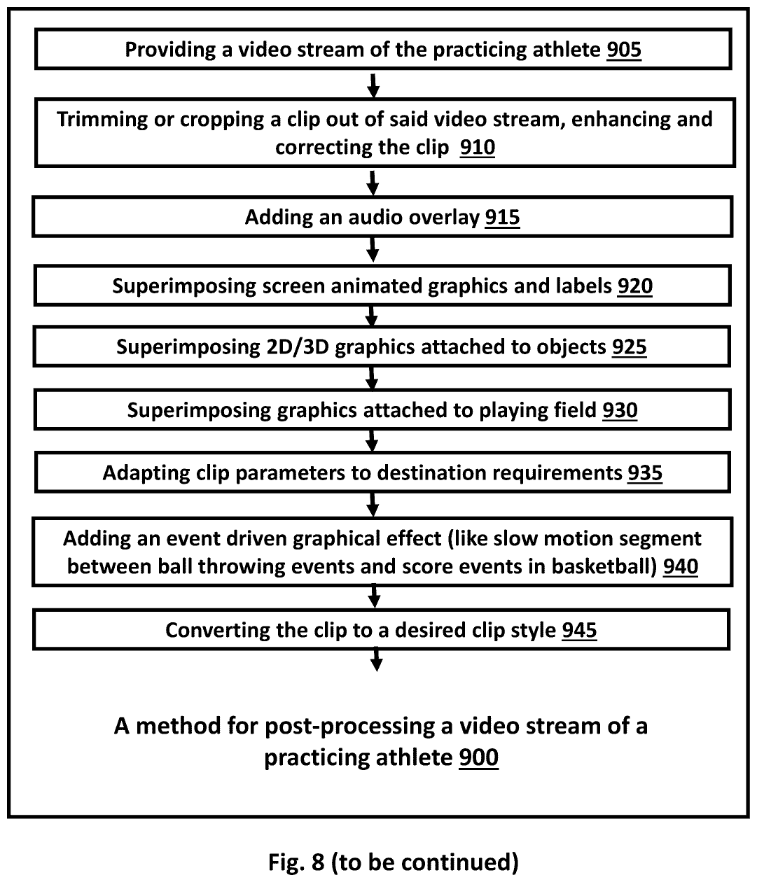

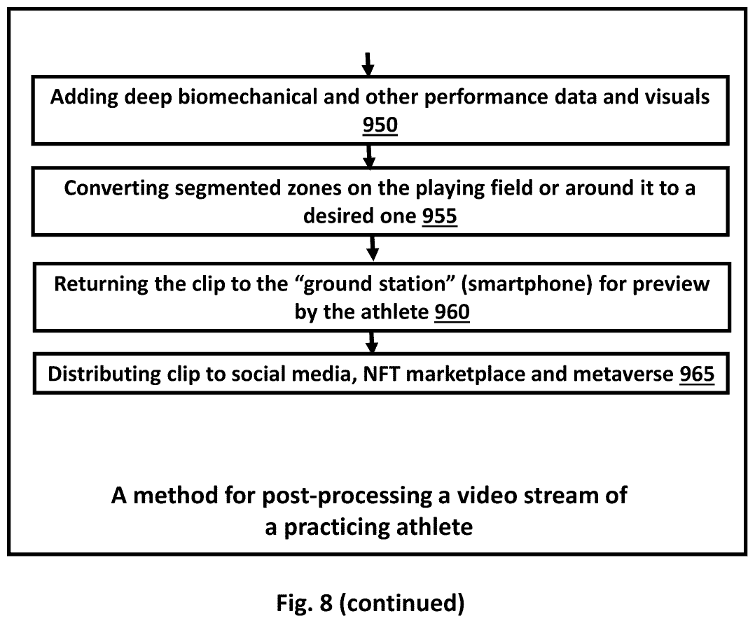

A method 900 for post processing of video streams capturing activity of a practicing athlete 18 is shown in the flowchart of FIG. 8. The method includes a step 905 of providing video streams of the athlete, a step 910 of trimming a clip out of a provided video stream, and enhancing and correcting the trimmed video clip, a step 915 of adding an audio overlay to the clip, a step 920 of superimposing screen animated graphics on the clip, and a step 960 or 965 of delivering the edited clip to a final destination or to an intermediate destination. An optional final destination is a social media platform 145, NFT marketplace 150 and sports metaverse environments 155. An optional intermediate destination is a smartphone of athlete 18 or of an assistant, who in turn submits the clip to the above final destinations.

In some embodiments, method 900 further includes steps like a step 925 of superimposing 2D/3D graphics attached to objects like ball 20 or backboard 30R, a step 930 of superimposing graphics attached to a playing field 10, a step 935 of adapting clip parameters to at least one requirement of a destination 145, 150 or 155, and a step 940 of adding an event driven graphical effect in accordance with an identified event in the clip. An example of step 940 is adding a slow-motion segment between events like ball throwing events or score events.

In some embodiments, method 900 further includes steps like a step 945 of converting the clip to a desired clip style, a step of producing a slow motion segment within the clip as described above in relation to step 940, a step 950 of adding deep biomechanical performance data or visual to the clip, and a step 955 of converting a segmented zone on the area to a desired zone.

1. A method for video capturing of an activity of at least one person in an area, the at least one person being associated with an adjustable camera and a processor, the method comprising:
a. capturing video streams of the area and the activity of said at least one person thereof;
c. analyzing at least one video stream for an analysis of operations of said at least one person;
d. determining at least one camera parameter in accordance with said analysis of operations of said at least one person; and
e. adjusting said at least one camera parameter in accordance with said determining of desired camera parameters,
wherein the method further comprises a step of interpreting a signal issued by the at least one person for the attention of the processor- and/or a step of said at least one person triggering an operation of said camera to follow the activity.

2. The method of claim 1 wherein said at least one camera parameter is selected from a group of camera parameters consisting of field of view, pan angle, tilt angle, a zoom parameter, and spatial coordinates of the camera.

3. (canceled)

4. (canceled)

5. The method of claim 1 wherein the signal issued by the person is captured by the adjustable camera.

6. The method of claim 1 wherein the signal issued by said at least one person includes a hand gesture or a finger gesture.

7. The method of claim 6 wherein the hand executing the gesture having a forearm, a palm, a thumb finger, an index finger, a middle finger and a little finger, and the hand gesture includes a combination of at least one pose selected from a group of poses consisting of:
A. a forearm-palm angle between 210° and 225°;
B. a forearm-palm angle between 170° and 190°;
C. a forearm-palm angle between 125° and 145°;
D. a forearm-palm angle between 80° and 100°;
D. a certain finger folded upon the palm;
E. a certain finger separated from adjacent fingers and stretched away of the palm;
F. a pair of certain adjacent fingers attached to one another and stretched away of the palm;
G. a forearm substantially vertical to the ground; and
H. a forearm substantially horizontal to the ground.

8. The method of claim 1 further comprising a step of acting in accordance with the interpreting of the signal issued by said at least one person, wherein said acting includes at least one of the steps:
A. issuing a signal for the attention of the at least one person;
B. adjusting at least one camera parameter selected from a group of camera parameters consisting of field of view, pan angle, tilt angle, a zoom parameter and the camera location in space.
C. playing a pre-recorded vocal feedback;
D. playing a synthetic vocal feedback;
E. displaying a message on a screen seen by said at least one person; and
F. triggering of a vibration in a smart watch of said at least one person.

9. (canceled)

10. The method of claim 1 further comprising a step of submitting at least one video stream to an associated computing device for said analyzing or for clip editing.

11. (canceled)

12. The method of claim 10 further comprising a step of receiving an edited clip.

13. (canceled)

14. The method of claim 1 wherein said at least one person is a player and determining and adjusting said at least one camera parameter responds to at least one of player location, player velocity, spread of players, play event recognition, and object detection.

15. The method of claim 1 further comprising calculating at least one present camera parameter using a video stream, said at least one present camera parameter is selected from a group of parameters consisting of the three location coordinates, a pan angle, a tilt angle, a roll angle, a zoom parameter and the camera location in space.

16. The method of claim 1 wherein the adjustable camera is one of a smartphone, a camera and a camera associated to a smartphone, in communication with the processor.

17. The method of claim 16 wherein the adjustable camera said adjustable is held by an adjustable base which includes at least one base selected from a group of adjustable bases consisting of a tripod, a pan unit on a tripod, a pan and tilt unit on a tripod, an extender, a stabilizer and a human operator.

18. The method of claim 1, wherein multiple adjustable cameras are located around the area, and the processor determines an identity of a camera to be embedded in the video clip or to go on air in a live casting event, and at least one camera parameter in accordance with the analysis of operations of said at least one person.

19. The method of claim 1, wherein at least one athlete is practicing in an area, the at least one athlete is associated with a camera-equipped drone, and the method comprising:
A. the drone hovering in a pre-specified flight zone;
B. the camera capturing video streams of the area and the practicing at least one athlete thereof;
C. analyzing at least one video stream for an analysis of operations of said at least one athlete and for a decision on desired shooting parameters;
D. determining desired drone maneuvering and desired camera alignment in accordance with said analysis of operations of said at least one athlete and in accordance with said decision on desired shooting parameters; and
E. said drone executing navigation instructions and desired camera parameter alignment in accordance with said determining drone maneuvering and camera alignment, and wherein the method further comprises a step of said drone issuing a signal for the attention of said at least one athlete.

20. (canceled)

21. The method of claim 19 said signal for the attention of said at least one athlete is selected from a group of signals consisting of:
1) an up and down drone motion;
2) a horizontal back and forth drone motion;
3) flickering of a LED (light emitting diode) on a part of said drone to notify a battery shortage;
4) issuing a pre-recorded vocal feedback or a synthetic vocal feedback on performance of said at least one athlete;
5) displaying a message on a screen seen by said at least one athlete; and
6) triggering of a vibration in a smart watch of said at least one athlete.

22. The method of claim 19 wherein the step of analyzing at least one video stream for analysis of operations of said at least one athlete and for a decision on desired shooting parameters includes at least one operation selected from a group of operations consisting of:
1) detecting sports objects, playing field lines and landmarks;
2) detecting and tracking the at least one athlete;
3) detecting a 3D (three dimension) pose of the at least one athlete;
4) recognizing sports events occurring in the area; and
5) recognizing detailed performance parameters.

23. The method of claim 19 further including comparing skeleton angles of a player along a drill to corresponding skeleton angles of an elite player.

24. (canceled)

25. (canceled)

26. The method of claim 19 further comprising a step of said at least one athlete issuing a signal for the attention of said drone, a step of interpreting the issued signal and a step of said drone acting in accordance with said interpreting the issued signal.

27. The method of claim 26 wherein said acting includes at least one of the steps:
1) issuing a signal for the attention of the at least one athlete;
2) executing a flight maneuver;
3) executing a camera alignment; and
4) providing immediate feedback to said at least one athlete, the immediate feedback responding to performance of said at least one athlete or advising regarding improving performance.

28. (canceled)

29. A method for automatic post processing of a video stream of an activity of at least one athlete comprising:
a. providing said video stream of said at least one athlete;
b. trimming a clip out of said video stream;
c. adding an audio overlay to said clip;
d. superimposing screen animated graphics on said clip; and
e. delivering the edited clip to an intermediate destination or to a final destination.

30. (canceled)

31. (canceled)

32. (canceled)
